(19) United States
(12) Patent Application Publication
(10) Pub. No.: US 2007/0255637 A1
(43) Pub. Date: Nov. 1, 2007

(54) Web-accessible financial product sales assistance system and method

(75) Inventor: Frederick A. Henry, Mequon, WI (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(73) Assignee: FIMSA, LLC, Mequon, WI (US)

(21) Appl. No.: 11/412,281

(22) Filed: Apr. 27, 2006

Related U.S. Application Data
(60) Provisional application No. 60/744,963, filed on Apr. 17, 2006.

(51) Int. Cl. G06Q 40/00

(52) U.S. Cl. 705/36 R

(57) ABSTRACT

An innovative interactive web-accessible financial product sales assistant system and method is disclosed which facilitates the sale of financial products such as annuities by providing prompts to agents accessing the system to obtain the direct online entry of all financial product sales information required by the providers of the financial products in order to place applications for the financial products in good order. The agents can use the Internet-accessible sales assistant system as an entry pad to be used while taking the information from the customer, with the system immediately noting incorrect or inappropriate entries, thereby making the sale process more efficient. The system runs a full check of the sales order when completed by the agent, and any errors are immediately bought to the attention of the agent so that they can be corrected, following which the annuity or other financial product may be purchased from the financial product provider.

### CROSS-REFERENCE TO RELATED APPLICATION

This patent application claims priority of U.S. Provisional Patent Application No. 60/744,963, which is entitled “Web-Accessible Financial Product Sales Assistance System and Method,” and which was filed on Apr. 17, 2006, which provisional patent application is hereby incorporated herein by reference in its entirety.

### BACKGROUND OF THE INVENTION

### FIELD OF THE INVENTION

The present invention relates generally to systems and tools for use in conjunction with the sale of financial products such as annuities, and more particularly to an improved interactive web-accessible financial product sales assistance system and method for facilitating the sale of financial products by providing prompts to agents accessing the system to obtain the direct online entry of all financial product sales information required by the providers of the financial products in order to place applications for the financial products in good order.

With an ever-increasing number of people having expectations of a relatively long period of retirement together with an awareness of the need to exercise careful financial planning for such a prolonged period of retirement, it has become progressively more important to ensure that retirees do not outlive their assets. For many searching for financial products upon which they can depend in retirement, annuities have become the desired financial product with which to supplement Social Security and other more traditional financial arrangements. Simply stated, annuities are agreements under which the seller of the annuity (typically a life insurance company, trust, or charity) contractually agrees to pay the buyer of the annuity a series or stream of payments. Annuities are especially desirable as retirement investment vehicles inasmuch as investment earnings in the annuities—capital gains and investment income—are not taxable until the money is withdrawn from the annuity.

Annuities can be purchased through a variety of parties, including banks, life insurance carriers, financial planners, and insurance agents, although annuity policies are issued only by life insurance companies. The sellers of annuities fall into two categories, the first of which is banks and brokerage firms, and the second of which is independent agencies. Products developed by life insurance companies are often marketed through banks and stock brokerage firms. If an annuity is purchased through a bank or brokerage firm, the buyer will typically deal with an agent who is an employee of the bank or brokerage firm and who is a licensed life insurance agent (and, in the case of variable annuities, a licensed securities dealer). If the annuity is purchased through an agency, the agent(s) at the agency will also be licensed, and may represent either a single insurance company or multiple companies.

While annuities are relatively simple in concept, the process of selling an annuity is extraordinarily complex. The paperwork which must be completed by the agent in order to complete the sale of the annuity is both long and relatively complex, and it requires a large amount of information to be obtained from the purchaser of the annuity. If the proper information is not presented to the insurance company selling the annuity, the insurance company will not validate the annuity, and this can present a problem, particularly if the terms of the annuity product change between the time the paperwork is improperly completed and the time that the error(s) is (are) corrected. Since any given agent may sell a wide variety of annuity products from a number of different insurance companies, it is to be expected that the paperwork varies considerably both with different types of annuities and with different insurance companies, and agents thus typically must deal with dozens of different types of paperwork in the course of selling the annuity products offered by their bank or agency.

In addition, agents, who are typically paid at least in part based upon commissions which may be received periodically (e.g., monthly) may have to wait an entire month to be paid if they have missed a periodic cutoff for commissions. Further, the banks or agencies for which the agents work typically receive fee income from the insurance companies selling the annuities on the same periodic basis, and it will thus be appreciated that it is quite important to the banks and agencies that the paperwork be properly filled out at the time of the initial sale of the annuity. For this reason, an elite financial specialty which has developed is the annuity order facilitator which stands between the agent meeting with the purchaser of the annuity and the insurance company selling the annuity.

The banks and agencies which sell annuities, in recognition of the importance of the fee income from selling the annuity products, now deal with financial transaction solution providers (such as the assignee of the present patent) to ensure that the orders for annuities are properly completed prior to their submission to the insurance companies selling the annuities. Such financial transaction solution providers offer effective sales training to the agents who are employees of the financial transaction solution providers' bank and agency clients, help the banks and agencies select appropriate annuity investment products, and provide ongoing support to banks and agencies of every size which desire to offer annuity products to their customers. In so doing, the financial transaction solution providers build mutually profitable long-term working relationships with their bank and agency clients.

The presently preferred method of servicing the large numbers of agents from banks and agencies selling annuities and other similar financial products offered by a large number of different insurance companies is through the use of a call center. Under this method, the agents call or fax in sales information after they have made a sale, and a call center employee takes the information and enters it into a computer program designed for this purpose. Once all of the necessary information for the sale of an annuity or other financial product has been entered into the computer program by the call center employee, the sale is said to be “in good order,” and the annuity or other financial product is purchased).

The call center employee typically has a data entry screen with many pop-up windows which request the appropriate information in a particular order. The pop-up windows are completely scripted and are dynamically based upon the particular annuity or other financial product which is being purchased. There is both a large amount and a wide variety of information which must be provided, and in many cases the agents do not have all of the needed information during the initial call, necessitating one or more follow-up calls with the call center. The call center employee thus prompts the agents for all of the information which is required for the purchase of the annuity or other financial product, thereby ensuring that when the order is submitted to the insurance company selling the annuity that the annuity purchase will be “in good order,” thereby enabling the expeditious purchase of the annuity or other financial product.

It may be appreciated that the services provided by financial transaction solution providers are invaluable to banks and agencies selling annuities and similar financial products. However, this service is not without cost, since it will be appreciated by those skilled in the art that a call center employee must spend time on making sure that the annuity purchase is “in good order,” and this practice is somewhat labor-intensive, requiring at least between three and thirty minutes of assistance per annuity purchase.

A brief review of the efforts of others in this area is also instructive. U.S. Pat. No. 6,856,679, to Pennington, Jr. et al., discloses a system and method to provide automated, end-to-end scripting to guide a customer service representative in handling a call from a customer. U.S. Patent Application Publication No. 2004/0044561, to Kolb et al., discloses a commercial vehicle customer economic value tool which directs a sales representative of commercial vehicles to query a customer and input salient information about the customer.

U.S. Pat. No. 6,826,745 and U.S. Patent Application Publication No. 2005/0086220, both to Coker et al., disclose a system and method for smart scripting call centers which uses scripts having hierarchical sets of structured pages. U.S. Pat. No. 6,581,067, to Bjergo et al., discloses a system and method for providing administrative support to customer service representatives. U.S. Patent Application Publication No. 2004/0158481, to Gennaro et al., discloses systems and methods for sales territory whitespacing. U.S. Patent Application Publication No. 2002/0156701, to Fultz, discloses an automated sales system for the moving and storage industry. However, none of these references provide an improvement to the financial transaction solution providers call centers mentioned above.

It is accordingly the primary objective of the present invention that it provide similar services to agents of banks and agencies selling annuities and other similar financial products to those currently provided by financial transaction solution providers call centers to place orders for the annuities and other similar financial products “in good order,” but more efficiently and at a lower cost. It is a related objective of the present invention that it use the Internet to provide a web-accessible financial product sales assistance system and method to perform the function currently performed by call center employees. It is another related objective of the present invention that it be capable of being integrated with an existing call center operation to service agents of banks and agencies which desire to continue using a call center at least in part.

It is another objective of the present invention that it be capable of working with any and all of the wide variety of annuities and other similar financial products available. It is yet another objective of the present invention that it be simple to use by the agents who are employees of the banks and agencies selling annuities and other similar financial products. It is still another objective of the present invention that it maximize efficiency and minimize cost in the selling and ordering of annuities and other similar financial products.

The web-accessible financial product sales assistance system and method of the present invention should be relatively straightforward to implement by a financial transaction solution provider while providing agents of banks or agencies selling annuities and other similar financial products with highly reliable operation which is always available. In order to enhance the market appeal of the web-accessible financial product sales assistance system and method of the present invention, it should be as economically beneficial as possible to its bank and agency customers to thereby afford it the broadest possible market. Finally, it is also an objective that all of the aforesaid advantages and objectives of the web-accessible financial product sales assistance system and method be achieved without incurring any substantial relative disadvantage.

### SUMMARY OF THE INVENTION

The disadvantages and limitations of the background art discussed above are overcome by the present invention. With this invention, an Internet-accessible software-operated system is provided which enables agents employed by banks and agencies to directly enter annuity sales order information by logging onto a secure website and providing the information directly via the website. The website may be thought of as providing a series of online smart forms which will walk the selling agent through entry of all of the necessary information.

Accordingly, the agent can use the website as an entry pad to be used while taking the information from the customer. The web-accessible financial product sales assistance system and method of the present invention thus provides screens and guides the agent through the entry of customer information including information relating to the suitability of various annuities and other financial products, the selection of a wide variety of products, the entry of all necessary policy information, and even the entry of the source of funding for the annuity or other financial product.

Since the web-accessible financial product sales assistance system prompts the agent or sales representative for all necessary information as well as immediately noting incorrect or inappropriate entries, the sale process will become more efficient. The web-accessible financial product sales assistance system also runs a full check of the sales order when completed by the agent and prior to sending it to the financial product provider. If there are any errors, they are immediately bought to the attention of the agent so that they can be corrected, following which the sales order is forwarded to the financial product provider for purchase of the annuity or other financial product.

Other features provided in the preferred embodiment are of assistance to the sales representatives in selling the financial products, and include complete online application information queries, a complete list of the financial products available and the details relating thereto, information relating to how the financial product will be funded, note entry areas, a wide variety of reports, and a database of financial products previously sold by the representatives, as well as previous customers, etc. It will be appreciated that the call center employees are largely eliminated (only a help line is necessary), resulting in a reduction in costs, as well as automating the system and making it available at any time rather than only during normal business hours.

It may therefore be seen that the present invention teaches a web-accessible financial product sales assistance system and method that provides a service to agents of banks and agencies selling annuities and other similar financial products that is similar to the service provided by financial transaction solution providers call centers to place orders for the annuities and other similar financial products “in good order,” but more efficiently and at a lower cost. The web-accessible financial product sales assistance system and method of the present invention uses the Internet to provide a web-accessible financial product sales assistance system and method to perform the function currently performed by call center employees. The web-accessible financial product sales assistance system and method of the present invention is also capable of being integrated with an existing call center operation to service agents of banks and agencies which desire to continue using a call center at least in part.

The web-accessible financial product sales assistance system and method of the present invention is capable of working with any and all of the wide variety of annuities and like financial products available. The web-accessible financial product sales assistance system and method of the present invention is simple to use by agents who are employees of the banks and agencies selling annuities and other similar financial products. The web-accessible financial product sales assistance system and method of the present invention maximizes efficiency and minimizes cost in the selling and ordering of annuities and other similar financial products.

The web-accessible financial product sales assistance system and method of the present invention is relatively straightforward to implement by a financial transaction solution provider, and provides agents of banks or agencies selling annuities and other similar financial products with a highly reliable operation which is always available. The web-accessible financial product sales assistance system and method is as economically beneficial as possible to its bank and agency customers to enhance its market appeal and to thereby afford it the broadest possible market. Finally, all of the aforesaid advantages and objectives of the web-accessible financial product sales assistance system and method are achieved without incurring any substantial relative disadvantage.

### DESCRIPTION OF THE DRAWINGS

These and other advantages of the present invention are best understood with reference to the drawings, in which:

FIG. 1 is a functional schematic diagram showing an implementation of the web-accessible financial product sales assistance system of the present invention;

FIG. 2 is a flow diagram depicting the operation of the web-accessible financial product sales assistance system of the present invention illustrated in FIG. 1;

FIG. 3 is a screen shot of a login screen which an agent can use to log into the web-accessible financial product sales assistance system of the present invention;

FIG. 4 is a screen shot showing the existing transactions on the web-accessible financial product sales assistance system of the present invention for a particular agent;

FIG. 5 is a screen shot of a screen which an agent can use to select a cost center or branch name for his/her bank or agency;

FIG. 6 is a screen shot of a screen which would be used instead of the screen shot shown in FIG. 5 if the user is at a call center and is assisting an agent who is unable to access the web-accessible financial product sales assistance system and method of the present invention directly;

FIG. 7 is a screen shot of a screen which an agent can use to indicate whether the sale is a new sale (a new customer) or an addition to an existing annuity or other financial product;

FIG. 8 is a screen shot of a screen which an agent can use to enter personal information for a new customer purchasing a first annuity or other financial product;

FIG. 9 is a screen shot of a screen which an agent can use to enter information relating to the suitability of the annuity or other financial product for the particular customer;

FIG. 10 is a screen shot of a screen which an agent can use to select a particular annuity or other financial product to be sold to a customer;

FIG. 11 is a screen shot of a screen which an agent can use to enter detailed information necessary for the purchase of the selected annuity or other financial product;

FIG. 12 is a screen shot of a screen which an agent can use to provide information relating to the source of funds to purchase the annuity or other financial product;

FIG. 13 is a screen shot of a screen which an agent can use to view information regarding a customer to whom an additional annuity or other financial product is being sold; and

FIG. 14 is a screen shot of a screen which an agent can use to enter notes relating to the particular customer or the sale of the annuity or other financial product to that customer.

### DETAILED DESCRIPTION OF THE PREFERRED EMBODIMENT

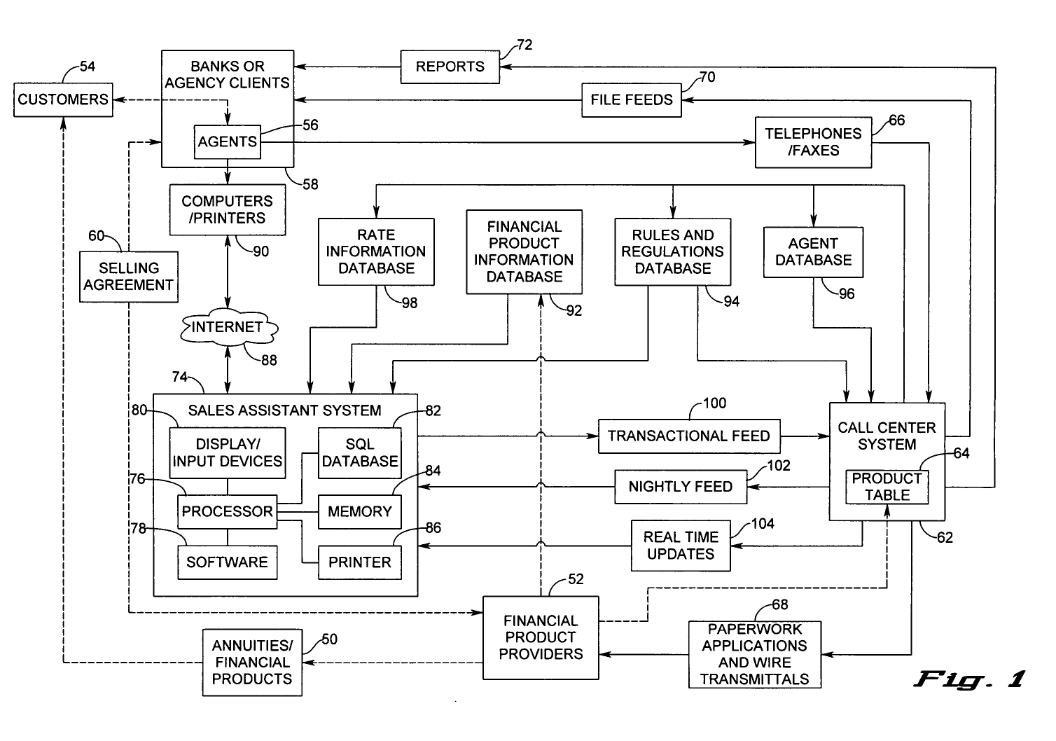

The preferred embodiment of the web-accessible financial product sales assistance system and method of the present invention is illustrated by way of example in FIG. 1, which depicts the participants as well as the principal components of the web-accessible financial product sales assistance system itself. Historically, annuities or like financial products 50 have been sold by financial product providers 52 to customers 54. Often, the annuities or like financial products 50 are sold by agents 56, who are typically employees of banks or agency clients 58 which have selling agreements 60 with the financial product providers 52.

The web-accessible financial product sales assistance system and method of the present invention adds two primary components and a number of secondary components. The first primary component is a call center system 62, which interacts between the financial product providers 52 on the one hand and the agents 56 and the banks or agency clients 58 on the other hand. The call center system 62 has a product table 64 which includes information about all of the annuities and other like financial products which are offered by the financial product providers 52. Information is provided by the financial product providers 52 to the product table 64 at the call center system 62 on an ongoing basis so that the product table 64 always remains current.

The call center system 62 may be used by the agents 56 to place orders for the annuities or other financial products. The agents 56 provide information regarding new sales of annuities or other financial products to the call center system 62 by telephones or faxes 66. The call center employees in the call center system 62 process orders for new sales of annuities or other financial products, and when they are “in good order” the call center system 62 sends the orders to the financial product providers 52 as paperwork applications and wire transmittals 68 (the paperwork applications are all the paperwork that the financial product providers 52 require, and the wire transmittals are the funds for the new annuities or other financial products which have been sold).

The call center system 62 provides a variety of information to the banks or agency clients 58. Specifically, the call center system 62 provides file feeds 70 to the banks or agency clients 58, typically on a daily basis. Alternately, the file feeds 70 may be more frequent updates, and they may optionally be real-time updates. The call center system 62 also provides a variety of reports 72 to the banks or agency clients 58, typically on an as-requested basis.

The second primary component of the web-accessible financial product sales assistance system and method of the present invention is a sales assistant system 74, which interacts with the call center system 62 as well as (and most notably) with the agents 56. The sales assistant system 74 is an entirely automated system which includes a processor 76 which operates using software 78 and is operatively connected to display/input devices 80, a SQL database 82 (which is used to store operational information such as information relating to orders and sales of annuities and other financial products), a memory 84, and a printer 86.

The sales assistant system 74 is accessed by the agents 56 via a network such as the Internet 88 using computers/printers 90. The sales assistant system 74 also utilizes data from several external databases, one of which is a financial product information database 92 which includes information provided by the financial product providers 52 regarding all of the annuities and other similar financial products which are offered by the financial product providers 52. The financial product information database 92 is updated on an ongoing basis by the financial product providers 52 so that the financial product information database 92 always remains current.

A rules and regulations database 94 is used to provide basic rules and regulation information (information, guidelines, and restrictions related to the selling of annuities and other financial products) to ensure that all sales of annuities and other financial products will meet with all applicable rules and regulations. The rules and regulations database 94 may be updated by the call center system 62, and information contained therein is utilized by both the sales assistant system 74 and the call center system 62. An agent database 96 is used to provide current information regarding the agents 56, including which of the agents 56 are able to sell and in what states they are licensed, as well as other pertinent information. The agent database 96 may also be updated by the call center system 62, and information contained therein is utilized by both the sales assistant system 74 and the call center system 62.

A rate information database 98 is used to provide information regarding the various rates which are utilized in the sale of annuities and other financial products. The rate information database 98 may be updated by the call center system 62, and information contained therein is utilized by the sales assistant system 74.

The sales assistant system 74 provides a transactional feed 100 to the call center system 62 on an ongoing basis as transactions are processed by the sales assistant system 74. The call center system 62 provides at least a nightly feed 102 of information to the sales assistant system 74, and in the preferred embodiment also provides real-time updates 104 to the sales assistant system 74.

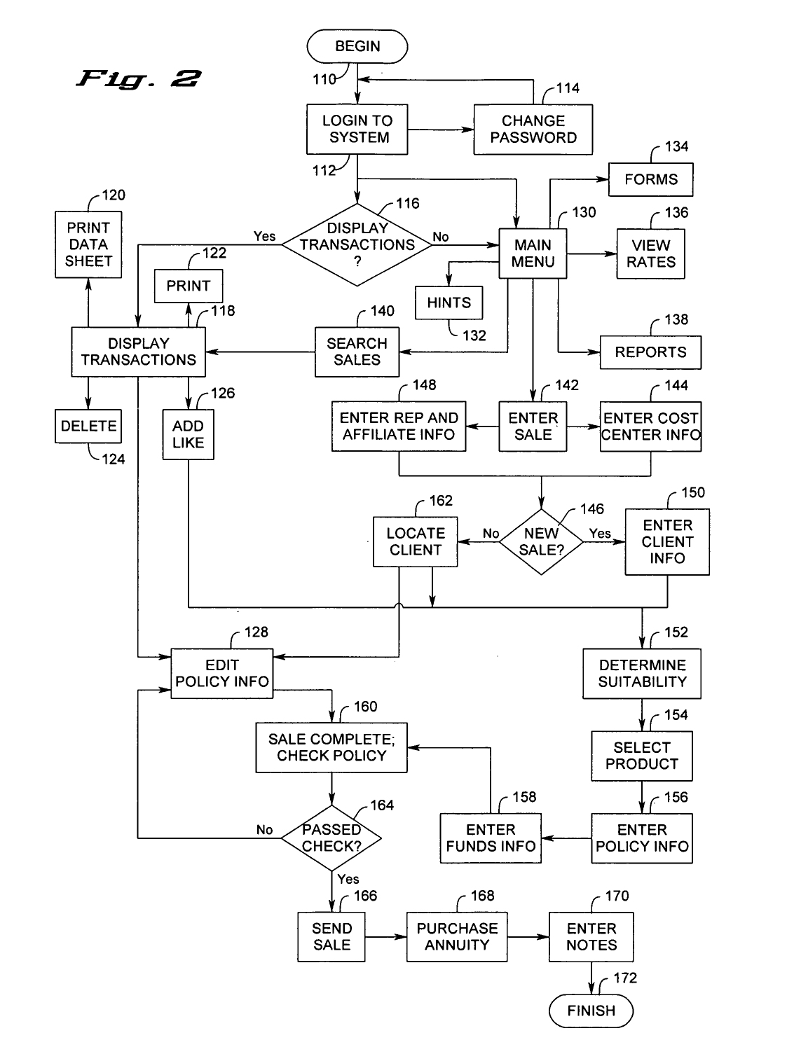

Referring next to FIG. 2, a flow diagram is shown which presents the operation of the web-accessible financial product sales assistance system and method illustrated in FIG. 1. The sales assistant system 74 is accessed by the agent 56 through the use of the computers/printers 90 (also illustrated in FIG. 1). The following discussion of the operation of the web-accessible financial product sales assistance system and method will also make reference to screen shots shown in FIGS. 3 through 14. The process begins with a process initiation step 100, and moves initially to a login to system step 112 during which the screen shown in FIG. 3 will be displayed to the agent 56.

The agent 56 (shown in FIG. 1) enters his/her username or ID and password, and the sales assistant system 74 (also shown together with its components in FIG. 1) will check these data entries against records stored in the SQL database 82. It may be noted that the information from the agent database 96 is provided by the call center system 62 to the sales assistant system 74, where it is stored in the SQL database 82. If the username and password entered by the agent 56 is correct, the sales assistant system 74 will log the agent 56 on.

If the username and password entered by the agent 56 is incorrect, the sales assistant system 74 will deny the agent 56 access to the sales assistant system 74. In this case, the agent 56 will have to call the call center system 62 for access to the sales assistant system 74. If the password of the agent 56 has expired, the system will move to a change password step 114 in which the agent 56 is prompted to select a new password. Following logon, the agent 56 may optionally have an opportunity to change the password even though it has not expired if he/she wishes to do so in the change password step 114.

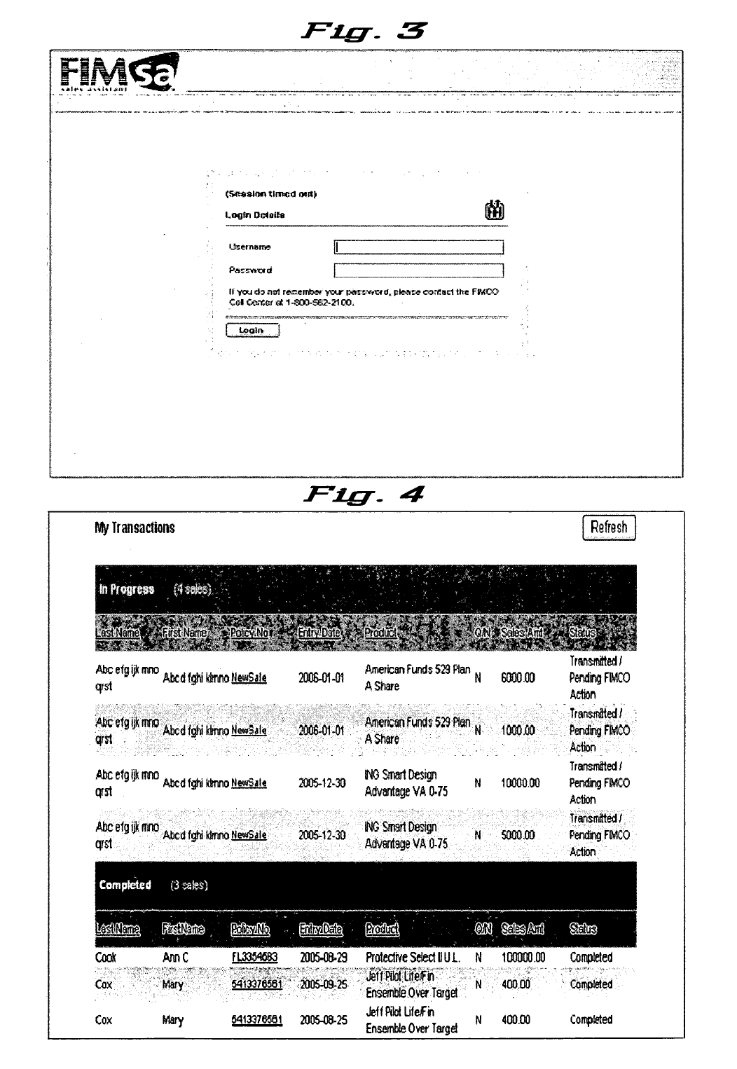

Following login, the agent 56 may opt to view his/her previous transactions in a display transactions determination step 116. If the agent 56 elects to view his/her previous transactions, the process moves to a display transactions step 118 in which the previous transactions of the agent 56 may be viewed. This is illustrated in the screen shown in FIG. 4. From the display transactions step 118, the agent 56 has four principal options which may be selected.

A data sheet for a selected previous transaction may be printed in a print data sheet step 120. Alternately, the details of the entire selected transaction may be printed in a print transaction step 122. Since the transactions displayed may include transactions which are not yet complete, there are two additional options which may be selected. A transaction which is not complete may be deleted in a delete transaction step 124. There is an add like step 126 which may be used to add an additional sale of an annuity or other financial product which is similar to a previous sale. Finally, there is an edit policy information step 128 which may be used to edit an unfinished sale of an annuity or other financial product which was begun earlier but not completed. The steps which follow these last two options will be discussed at a later point herein.

Returning to the display transactions determination step 116, if, on the other hand, the agent 56 does not elect to view his/her previous transactions, the process moves instead to a display main menu step 130. From the display main menu step 130, the agent 56 has six principal options which may be selected. At any time, the agent 56 may select a hints step 132 which will automatically provide the agent 56 with context-sensitive assistance. A display forms step 134 may be used to allow the agent 56 to view any of the forms which are associated with the various annuities or financial products which are available for the agent 56 to sell.

A view rates step 136 may be used to allow the agent 56 to view any of the current rates which are applicable to the various annuities or financial products which are available for the agent 56 to sell. The rate information is provided by the rate information database 98 (illustrated in FIG. 1) to the sales assistant system 74 (also illustrated in FIG. 1). An access reports step 138 may be used to allow the agent 56 to view and/or print any of a variety of reports which are relevant to the activities of the agent 56. It may also be noted that the banks or agency clients 58 also are able to print reports which are applicable to the sales of their agents 56.

Another option which is available to the agent 56 is a search sales step 140, wherein the agent 56 can enter data and locate transactions which contain the data entered. From the search sales step 140, the process will move to the display transactions step 118 wherein the transactions fitting the search criteria may be viewed by the agent 56. The final option which is available to the agent 56, and the most important of the options available from the display main menu step 130, is an enter sale step 142 in which the agent 56 begins the process of selling an annuity or other financial product.

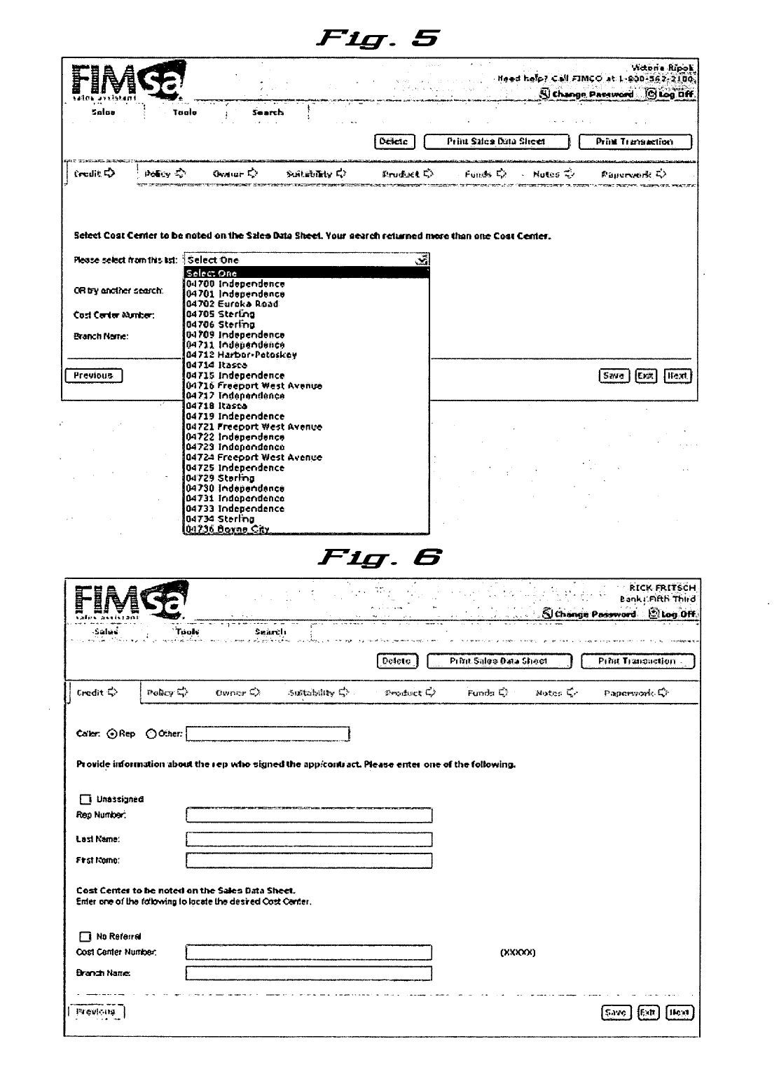

Once the agent 56 has selected the enter sale step 142, the process moves to an enter cost center information step 144 in which the agent 56 can enter a cost center or branch name which is the entity on behalf of which the agent 56 is selling the annuity or other financial product. This step is illustrated in the screen shown in FIG. 5. This step is necessary from an accounting standpoint to ensure that the credit for the sale is attributed to the proper cost center or branch.

Once the agent 56 has entered the cost center or branch, the process will move to a new sale determination step 146. In passing, it should be noted that in the event the agent 56 cannot access the sales assistant system 74 for some reason, the agent 56 may also call the sale in to the call center system 62 (illustrated in FIG. 1). In this event, an employee of the call center system 62 will perform an analog to the enter cost center information step 144. In an enter rep and affiliate step 148, the employee of the call center system 62 will enter the information for the sale of the annuity or other financial product, beginning with the screen shown in FIG. 6. This process would begin with the employee of the call center system 62 entering the name of the agent 56, and the cost center or branch name on behalf of which the agent 56 is selling the annuity or other financial product. Following this step, the process would move to the new sale determination step 146.

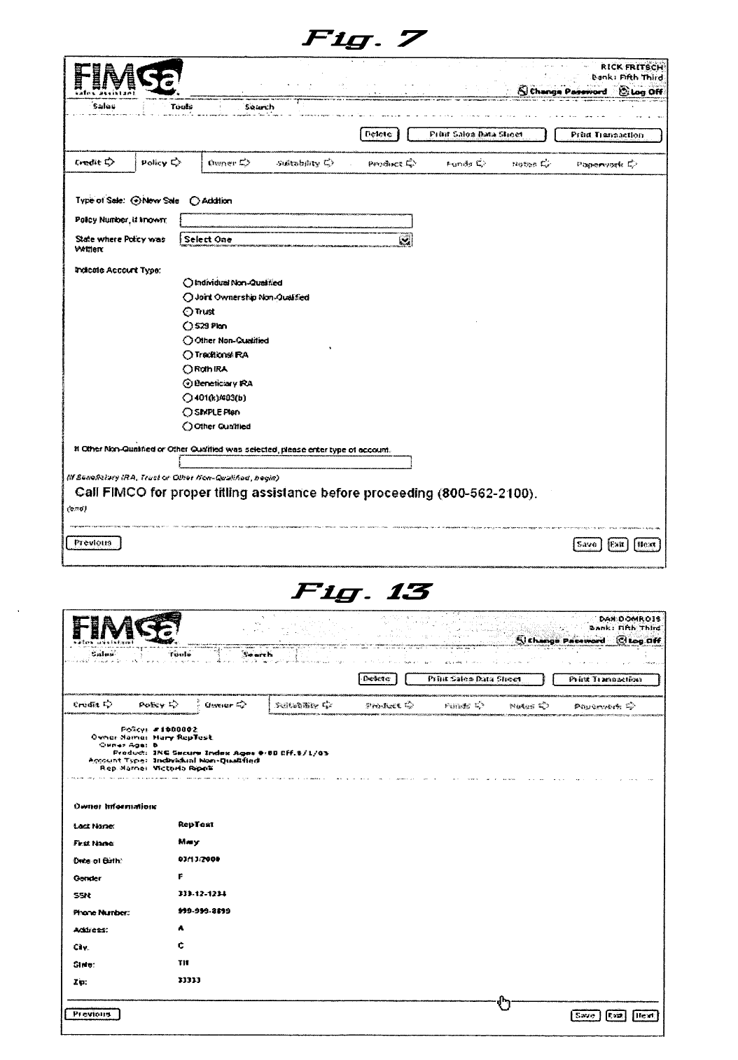

In the new sale determination step 146, the agent 56 will view a screen like the one shown in FIG. 7, and will have the opportunity to indicate whether the sale is a new sale or an additional sale (a sale being made to a customer to whom an annuity or other financial product was previously sold). If the agent 56 indicates that the sale is a new sale, the agent 56 may also add information including the policy number if known, the state where the policy is being written, and the account type (individual non-qualified, joint ownership non-qualified, trust, 529 plan, other non-qualified, traditional IRA, Roth IRA, beneficiary IRA, 401(k)/403(b), SIMPLE plan, etc.). The process then moves to an enter client information step 150 using a screen which is illustrated in FIG. 8.

In the enter client information step 150, the agent 56 views a screen like the one shown in FIG. 8, and enters information including the customer's name, address, date of birth, social security number, etc. Typically, this information is entered by the agent 56 during a meeting or telephone conference with the customer 54. The owner display shown in FIG. 8 includes information on a joint owner, but can alternately include information on an annuitant or information on a beneficiary. Following entry of ownership information in the enter client information step 150, the process next moves to a determine suitability step 152.

In the determine suitability step 152, the agent 56 views a screen like the one shown in FIG. 9, and enters information which is directed toward ensuring that the annuity or other financial product is appropriate for the customer. For new accounts, this information is also required by Federal laws such as the Customer Identification and Verification (CIP) Requirements of the Patriot Act. Typically, this information is also entered by the agent 56 during a meeting or telephone conference with the customer 54. An error message will appear if any of the required information is missing or invalid. Both during this step and at other points during the entry of information by the agent 56, the sales assistant system 74 may optionally provide an indication to the agent 56 regarding any errors made in the entry of information by the agent in real time. Following completion of the information in the determine suitability step 152, the process then moves to a select product step 154.

In the select product step 154, the agent 56 views a screen like the one shown in FIG. 10, and enters information which is directed toward the selection of the annuity or other financial product. Typically, the product carrier is selected first, followed by the product family and the product plan. In the preferred embodiment, only financial products which are appropriate for the particular customer are shown (for example, based on the customer's age, certain financial products may not be available). Following completion of the information in the select product step 154, the process then moves to an enter policy information step 156.

In the enter policy information step 156, the agent 56 views a screen like the one shown in FIG. 11, and enters information which is directed toward the rates of the policy as well as being generally directed toward the customer's investment information and strategy. The rate information may be provided by the rate information database 98 (illustrated in FIG. 1) to the sales assistant system 74 (also illustrated in FIG. 1). It will be appreciated by those skilled in the art that the requested information relating to the customer's investment information and strategy will vary according to the annuity or other financial product which is being purchased. Following completion of the enter policy information step 156, the process then moves to an enter funds information step 158.

In the enter funds information step 158, the agent 56 views a screen of which one example is shown in FIG. 12, and enters information which indicates the source of the funds for the annuity or other financial product. It will be appreciated that the screen will vary considerably in appearance based upon its context, due to the type of financial product and other sale-related information. The screen shown in FIG. 12 includes logic which is dynamically used to determine which questions will appear on the actual screen which an agent 56 would view during the enter funds information step 158. Additional screens would be used as needed to obtain additional information.

The process next moves to a sale complete/check policy step 160 in which the sales assistant system 74 will run a complete check of the information entered to determine whether the information for purchasing the new annuity or other financial product is “in good order.” Prior to describing that process in more detail, it is necessary to return for the moment to the new sale determination step 146. If, on the other hand, the agent 56 indicates in the new sale determination step 146 that the sale of an annuity or other financial product is not a new sale, the agent 56 may also add information relating to a previous sale such as the policy number if known, the state where the previous policy was written, and the account type. Following entry of this information, the process moves to a locate client step 162.

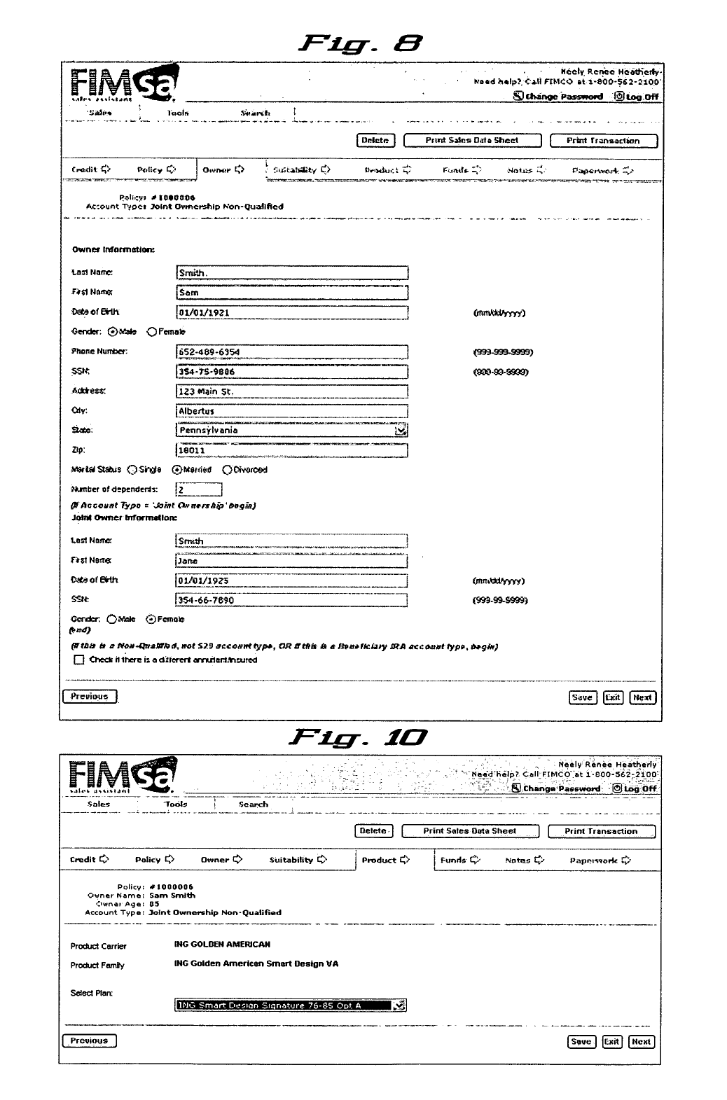

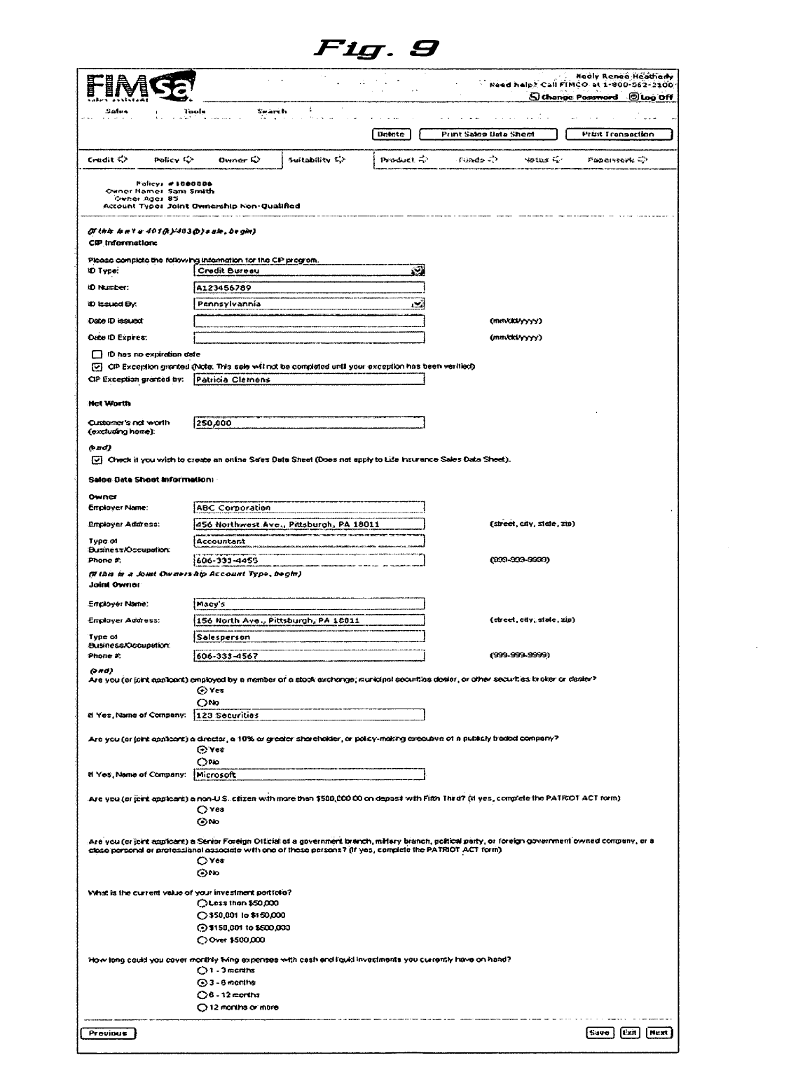

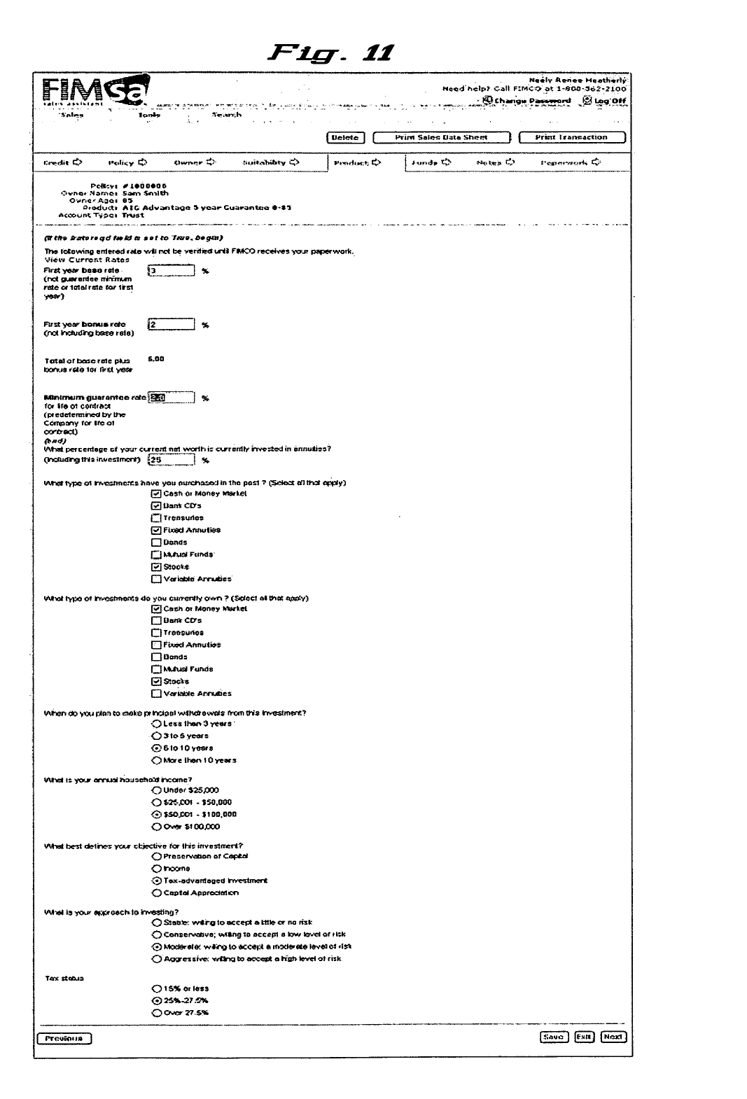

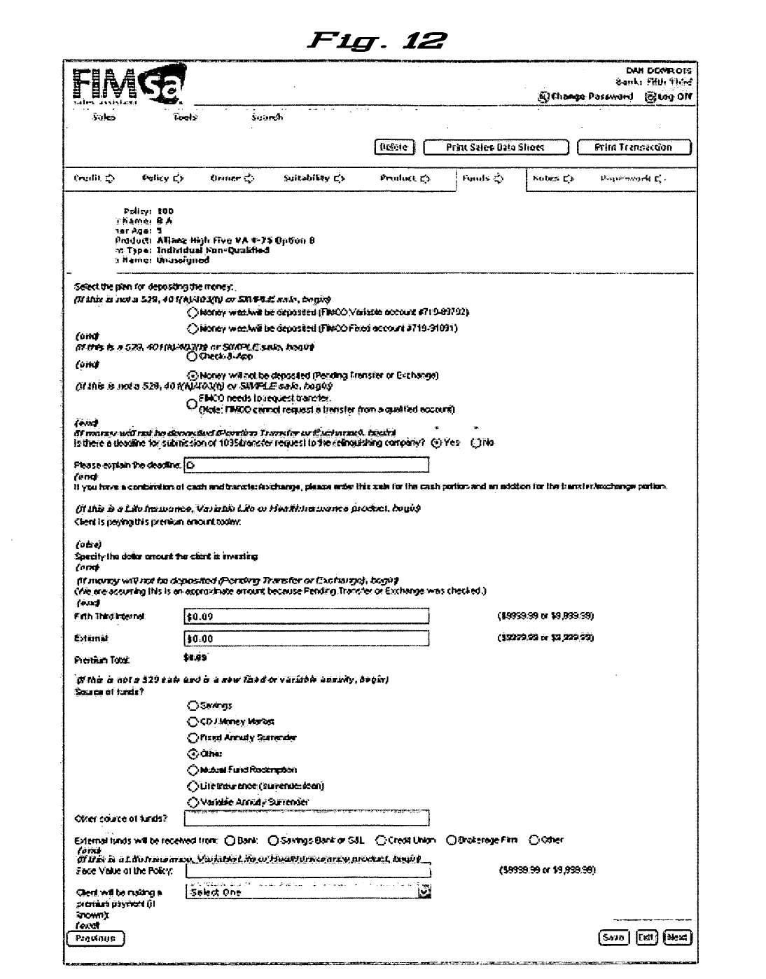

In the locate client step 162, the agent 56 views a screen like the one shown in FIG. 13, and enters information which is directed toward locating the client for whom previous sale activity has occurred. Once the client in question has been located, the process can move either to the edit policy information step 128 to add additional information to complete an as yet incomplete sale, or to the determine suitability step 152 to sell an additional annuity or other financial product to the repeat customer. From the edit policy information step 128, the sale information, when completed, allows the process to move to the sale complete/check policy step 160 for a determination of whether the now-completed information for purchasing the new annuity or other financial product is “in good order.”

From the sale complete/check policy step 160, the process moves to a passed check determination step 164 in which it is determined whether or not the review determined that the sale information was “in good order.” If it is determined that the sale information was not “in good order,” then the process returns to the edit policy information step 128 where the agent 56 may edit the sale information to correct the errors, which will in the preferred embodiment be highlighted for the benefit of the agent 56. If, on the other hand, it is determined in the passed check determination step 164 that the sale information is “in good order,” the process moves instead to a send sale step 166.

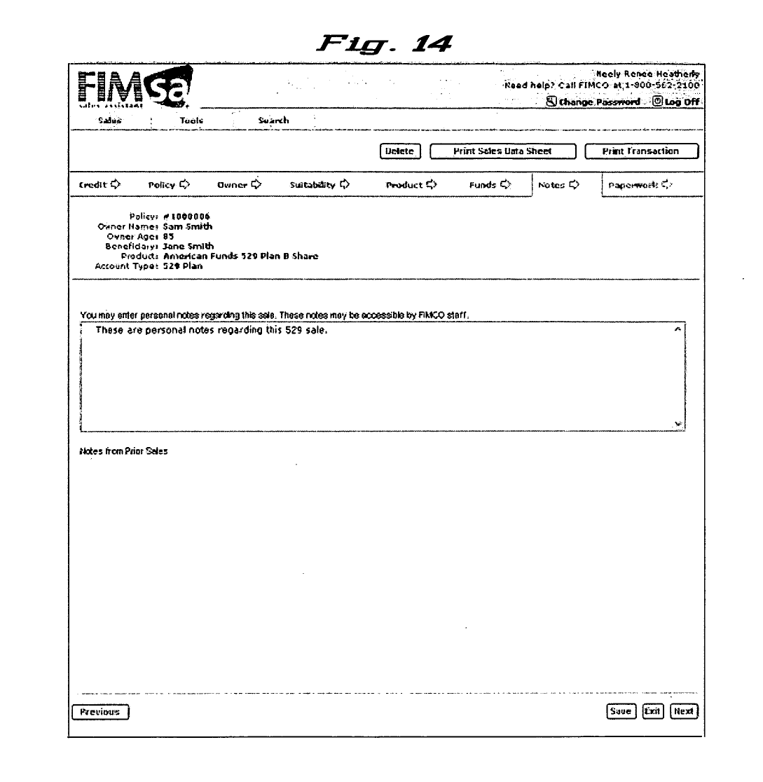

In the send sale step 166, the information for the purchase of the annuity or other financial product is sent by the sales assistant system 74 (shown in FIG. 1) to the financial product provider 52 (also shown in FIG. 1). (Since most financial product providers still require paper, paper copies may be printed and signed and sent to the financial product providers to comply with their formalities requirements.) The annuity or other financial product is then sold by the financial product provider 52 in a purchase annuity step 168. The funding of the annuity or other financial product has been executed according to the information entered by the agent 56, who completes his/her use of the web-accessible financial product sales assistance system and method of the present invention by entering any notes in an enter notes step 170 using a screen such as the one shown in FIG. 14. The process then terminates in a process completion step 172.

Following the sale of the annuity or other financial product, the financial product provider 52 who sold the annuity or other financial product compensates the bank or agency client 58 employing the agent 56, with the bank or agency client 58 then compensating the operators of the sales assistant system 74 for their services. Since the sales assistant system 74 automatically checks all sales orders of annuities and other financial products prior to sending them to the financial product providers 52, it will be appreciated that all orders submitted to the financial product providers 52 are “in good order.” Finally, the agents 56 are automatically prompted to correct the sales information, and the sales assistant system 74 is far less labor-intensive than is the operation of the call center system 62.

It may therefore be appreciated from the above detailed description of the preferred embodiment of the present invention that it provides a web-accessible financial product sales assistance system and method that provides a service to agents of banks and agencies selling annuities and other similar financial products that is similar to the service provided by financial transaction solution providers call centers to place orders for the annuities and other similar financial products “in good order,” but more efficiently and at a lower cost. The web-accessible financial product sales assistance system and method of the present invention uses the Internet to provide a web-accessible financial product sales assistance system and method to perform the function currently performed by call center employees. The web-accessible financial product sales assistance system and method of the present invention is also capable of being integrated with an existing call center operation to service agents of banks and agencies which desire to continue using a call center at least in part.

The web-accessible financial product sales assistance system and method of the present invention is capable of working with any and all of the wide variety of annuities and like financial products available. The web-accessible financial product sales assistance system and method of the present invention is simple to use by agents who are employees of the banks and agencies selling annuities and other similar financial products. The web-accessible financial product sales assistance system and method of the present invention maximizes efficiency and minimizes cost in the selling and ordering of annuities and other similar financial products.

The web-accessible financial product sales assistance system and method of the present invention is relatively straightforward to implement by a financial transaction solution provider, and provides agents of banks or agencies selling annuities and other similar financial products with a highly reliable operation which is always available. The web-accessible financial product sales assistance system and method is as economically beneficial as possible to its bank and agency customers to enhance its market appeal and to thereby afford it the broadest possible market. Finally, all of the aforesaid advantages and objectives of the web-accessible financial product sales assistance system and method are achieved without incurring any substantial relative disadvantage.

Although the foregoing description of the web-accessible financial product sales assistance system and method of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. An automatic, computer-implemented method of assisting agents in the sales of financial products offered by financial product providers to customers, said method comprising:
providing a first computer accessing information relating to financial products offered by a plurality of financial product providers;
selectively allowing an agent to access said first computer with a second computer located remotely from said first computer;
prompting said agent to enter information relating to a customer seeking to purchase a financial product;
based upon information relating to said customer entered by said agent, determining which of said financial products are suitable for sale to said customer;
prompting said agent to select a particular financial product for sale to said customer from said financial products which are suitable for sale to said customer;
based upon selection of a particular financial product for sale to said customer by said agent, prompting said agent to enter additional information needed to process the sale of said particular financial product to said customer;
automatically checking to determine whether the information provided by said agent regarding the sale of said particular financial product to said customer is sufficient to place said sale request “in good order;”
if said checking step determines that said information provided by said agent regarding the sale of said particular financial product to said customer is not sufficient to place said sale request “in good order,” automatically prompting said agent to make appropriate changes to said information provided by said agent regarding the sale of said particular financial product to said customer to place said sale request “in good order;” and
if said checking step determines that said information provided by said agent regarding the sale of said particular financial product to said customer is sufficient to place said sale request “in good order,” placing said sale request with the financial product provider selling said particular financial product.

2. A method as defined in claim 1, wherein said financial products include annuities.

3. A method as defined in claim 1, wherein said second computer accesses said first computer via the Internet.

4. A method as defined in claim 1, wherein said first computer system accesses a financial product information database containing information provided by said plurality of financial product providers regarding the financial products which are offered by said plurality of financial product providers, said financial product information database being updated on an ongoing basis by said plurality of financial product providers so that information contained in said financial product information database regarding the financial products which are offered by said plurality of financial product providers always remains current.

5. A method as defined in claim 1, wherein said first computer system accesses an agent database containing information regarding agents who may access said first computer system, wherein said selectively accessing step comprises:
prompting said agent to provide an ID and a password to initiate access to said first computer system from said second computer system; and
checking said ID and said password provided by said agent against information stored in said agent database and allowing said agent to initiate access to said first computer system only if said ID and said password provided by said agent are valid.

6. A method as defined in claim 1, wherein said first computer system accesses a rules and regulations database containing information, guidelines, and restrictions related to the selling of said financial products, wherein the information contained in said rules and regulations database is used for at least one of the following purposes:
to determine which of said financial products are suitable for sale to said customer;
to ascertain additional information needed to process the sale of said particular financial product to said customer; and
to determine whether said sale request is “in good order.”

7. A method as defined in claim 1, wherein said first computer system accesses a rate information database containing information regarding the various rates which are utilized in the sale of said financial products, wherein the information contained in said rate information database is used as said agent enters said additional information needed to process the sale of said particular financial product to said customer.

8. A method as defined in claim 1, wherein said agent is an employee of a bank or an agency, and wherein said bank or agency has selling agreements with said financial product providers.

9. A method as defined in claim 1, additionally comprising:
providing reports and/or electronic information regarding sales of financial products by said agent to said agent and/or to said bank or agency.

10. A method as defined in claim 1, additionally comprising:
transmitting all completed paperwork required by said financial product provider selling said particular financial product to said financial product provider selling said particular financial product.

11. A method as defined in claim 1, additionally comprising:
prompting said agent to enter information regarding the source of funds for said sale of said particular financial product to said customer; and
obtaining funds from said source of funds for said sale of said particular financial product to said customer.

12. A method as defined in claim 11, additionally comprising:
sending the funds for said sale of said particular financial product to said customer to said financial product provider selling said particular financial product.

13. A method as defined in claim 1, additionally comprising:
retaining information regarding said customer in a sales assistant system database;
retaining information regarding the sale of said particular financial product to said customer in said sales assistant system database; and
using said information in said sales assistant database for any future sales of financial products to said customer.

14. A method as defined in claim 13, additionally comprising:
upon request by said agent, displaying prior sales of financial products to customers, both completed and incomplete, which were initiated or made by said agent.

15. A method as defined in claim 1, additionally comprising:
allowing said agent to enter notes regarding said sale of said particular financial product to said customer in a sales assistant system database; and
allowing said agent to access previously entered notes regarding the sale of financial product to a customer in said sales assistant system database.

16. A method as defined in claim 1, additionally comprising:
providing guidance to said agent of mistakes made in the entry of information by the agent substantially in real time.

17. A method as defined in claim 1, additionally comprising:
allowing a call center employee to access said first computer with a third computer;
wherein said call center employee is available via telephone to provide assist to said agent and/or to enter information received from said agent instead of said agent entering said information directly.

18. An automatic, computer-implemented method of assisting agents in the sales of financial products offered by financial product providers to customers, said method comprising:
providing a first computer accessing information relating to financial products offered by a plurality of financial product providers;
selectively allowing an agent to access said first computer via a network with a second computer located remotely from said first computer;
prompting said agent to enter information relating to a customer seeking to purchase a financial product;
based upon information relating to said customer entered by said agent, information provided and updated by said plurality of financial product providers regarding the financial products which are offered by said plurality of financial product providers, and upon information contained in a rules and regulations database containing information, guidelines, and restrictions related to the selling of said financial products, determining which of said financial products are suitable for sale to said customer;
prompting said agent to select a particular financial product for sale to said customer from said financial products which are suitable for sale to said customer;
based upon selection of a particular financial product for sale to said customer by said agent and upon information contained in said rules and regulations database, prompting said agent to enter additional information needed to process the sale of said particular financial product to said customer;
automatically checking to determine whether the information provided by said agent regarding the sale of said particular financial product to said customer is sufficient to place said sale request “in good order;”
if said checking step determines that said information provided by said agent regarding the sale of said particular financial product to said customer is not sufficient to place said sale request “in good order,” automatically prompting said agent to make appropriate changes to said information provided by said agent regarding the sale of said particular financial product to said customer to place said sale request “in good order;” and
if said checking step determines that said information provided by said agent regarding the sale of said particular financial product to said customer is sufficient to place said sale request “in good order,” placing said sale request with the financial product provider selling said particular financial product.

19. An automatic, computer-implemented method of assisting agents in the sales of financial products offered by financial product providers to customers, said method comprising:
prompting an agent to enter information relating to a customer seeking to purchase a financial product;
based upon information relating to said customer entered by said agent, prompting said agent to select a suitable financial product for sale to said customer;
prompting said agent to enter information needed to process the sale of a selected suitable financial product to said customer;
prompting said agent to make any necessary changes to said information provided by said agent regarding the sale of said particular financial product to said customer which are necessary to place said sale request “in good order;” and
when sale request has been put “in good order,” placing said sale request with the financial product provider selling said particular financial product.

20. An automatic financial product sales assistance system for assisting agents in the sales of financial products offered by financial product providers to customers, said web-accessible financial product sales assistance system comprising:
a first computer accessing information relating to financial products offered by a plurality of financial product providers;
a second computer located remotely from said first computer which may be utilized by an agent to selectively access said first computer;
wherein said first computer causes said second computer to prompt said agent to enter information relating to a customer seeking to purchase a financial product;
wherein, based upon information relating to said customer entered by said agent, said first computer system determines which of said financial products are suitable for sale to said customer and causes said second computer system to prompt said agent to select a particular financial product for sale to said customer from said financial products which are suitable for sale to said customer;
wherein, based upon selection of a particular financial product for sale to said customer by said agent, said first computer system causes said second computer system to prompt said agent to enter additional information needed to process the sale of said particular financial product to said customer;
wherein said first computer system automatically checks to determine whether the information provided by said agent regarding the sale of said particular financial product to said customer is sufficient to place said sale request “in good order;”
wherein, if said first computer system determines that said information provided by said agent regarding the sale of said particular financial product to said customer is not sufficient to place said sale request “in good order,” automatically causing said second computer system to prompt said agent to make appropriate changes to said information provided by said agent regarding the sale of said particular financial product to said customer to place said sale request “in good order;” and
wherein, if said first computer system determines that said information provided by said agent regarding the sale of said particular financial product to said customer is sufficient to place said sale request “in good order,” said first computer system places said sale request with the financial product provider selling said particular financial product.
